(19) United States
(12) Patent Application Publication
(10) Pub. No.: US 2014/0290804 A1
(43) Pub. Date: Oct. 2, 2014

(54) SILICON EUTECTIC ALLOY COMPOSITION AND METHOD OF MAKING BY ROTATIONAL CASTING

(71) Applicant: Dow Corning Corporation, Midland, MI (US)

(72) Inventors: Zachary Bauer, Hemlock, MI (US); Jeremy Beebe, Midland, MI (US); Matthew Gave, Saginaw, MI (US); Daren Roehl, Midland, MI (US); Vasgen Shamamian, Midland, MI (US); Randall Siegel, Midland, MI (US); Joseph Sootsman, Freeland, MI (US); James Young, Midland, MI (US)

(21) Appl. No.: 14/305,465

(22) Filed: Jun. 16, 2014

Related U.S. Application Data
(63) Continuation of application No. PCT/US2012/071186, filed on Dec. 21, 2012.
(60) Provisional application No. 61/579,917, filed on Dec. 23, 2011.

(51) Int. Cl. C01B 33/02; B22D 27/04; B22D 13/00

(52) U.S. Cl. CPC C01B 33/02; B22D 13/00; B22D 27/045
USPC 148/404; 148/539

(57) ABSTRACT

To carry out a rotational casting method of preparing a silicon eutectic alloy composition, silicon and one or more metallic elements M are melted together to form a eutectic alloy melt comprising the silicon and the one or more metallic elements M. A mold containing the eutectic alloy melt is rotated about a longitudinal axis thereof at a speed sufficient to form a rotating volume of the eutectic alloy melt in contact with an inner surface of the mold. Heat is directionally removed from the rotating volume of the eutectic alloy melt to directionally solidify the eutectic alloy melt, and a eutectic alloy composition, which includes the silicon, the one or more metallic elements M, and a eutectic aggregation of a first phase comprising the silicon and a second phase of formula MSi₂, where the second phase is a disilicide phase, is formed.

### CROSS-REFERENCE TO RELATED APPLICATIONS

This patent application is a continuation of International Patent Application No. PCT/US2012/071186, filed Dec. 21, 2012, which claims priority to U.S. Provisional Patent Application No. 61/579,917, filed Dec. 23, 2011. Each of the above-identified patent applications is incorporated herein by reference in its entirety.

### TECHNICAL FIELD

The present disclosure is directed generally to eutectic alloys and more particularly to eutectic alloy compositions comprising silicon (Si).

### BACKGROUND

A need exists for corrosion- and wear-resistant ceramic components with good fracture toughness in numerous industries. While common technical ceramics such as silicon carbide, silicon nitride and others may be capable of filling this need at small scales for some applications, the powder pressing techniques by which they are made limit the size of parts available.

It has recently been recognized that silicon eutectic alloys, which may have properties competitive with technical ceramics, can be fabricated by melting and casting processes (see, e.g., WO 2011/022058). A challenge has been fabricating such alloys with sufficient control over the melting and casting process to achieve an oriented eutectic microstructure exhibiting a desirable set of mechanical properties.

### BRIEF SUMMARY

Described herein is a rotational casting method to fabricate silicon eutectic alloy compositions having an oriented eutectic microstructure and exhibiting fracture toughness values that exceed those of previously produced eutectic alloys.

According to one embodiment, the silicon eutectic alloy composition comprises a body comprising a eutectic alloy including silicon, one or more metallic elements M, and a eutectic aggregation of a first phase comprising the silicon and a second phase of formula MSi_{2,} where the second phase is a disilicide phase. One of the first and second phases of the eutectic aggregation comprises one or more colonies of substantially aligned high aspect ratio structures, and the body comprises a fracture toughness of at least about 3.2 megaPascals·meter^{1/2} (Mpa·m^{1/2}).

According to another embodiment, the silicon eutectic alloy composition comprises a body having symmetry about a longitudinal axis thereof and comprising a eutectic alloy including at least silicon, one or more metallic elements M, and a eutectic aggregation of a first phase comprising the silicon and a second phase of formula MSi_{2,} where the second phase is a disilicide phase. One of the first and second phases of the eutectic aggregation comprises high aspect ratio structures oriented along a radial direction with respect to the longitudinal axis. The body may also have a fracture toughness of at least about 3.2 MPa·m^{1/2}.

To carry out the rotational casting method, silicon and one or more metallic elements M are melted together to form a eutectic alloy melt comprising silicon and the one or more metallic elements M. A mold containing the eutectic alloy melt is rotated about a longitudinal axis thereof at a speed sufficient to form a rotating volume of the eutectic alloy melt in contact with an inner surface of the mold. Heat is directionally removed from the rotating volume of the eutectic alloy melt so as to directionally solidify the eutectic alloy melt, and a eutectic alloy composition, which includes the silicon, the one or more metallic elements M, and a eutectic aggregation of a first phase comprising the silicon and a second phase of formula MSi₂, where the second phase is a disilicide phase, is formed.

The silicon eutectic alloy composition may be advantageously used in any of a number of industries, such as the oil and gas, semiconductor, automotive, machine parts and solar industries, in which a component exhibiting good fracture toughness and other favorable mechanical properties is desired.

### BRIEF DESCRIPTION OF THE DRAWINGS

FIG. 1 is a Cr—Si phase diagram obtained from ASM Alloy Phase Diagrams Center, P. Villars, editor-in-chief, H. Okamoto and K. Cenzual, section editors, ASM International, Materials Park, Ohio, USA, 2006-2011;

FIG. 2 is an optical microscope image of rod-like reinforcement phase structures aligned perpendicular to the surface of a eutectic alloy sample prepared by directional solidification;

FIG. 3 shows an exemplary rotational casting apparatus;

FIG. 4 shows an exemplary temperature history during rotational casting from both within the Si—CrSi₂ rotationally cast material (diamonds) and external to the mold surface (squares);

FIGS. 5A and 5B are optical microscope images of an exemplary Si—CrSi₂ eutectic alloy prepared by rotational casting, where the sample was polished perpendicular to the growth direction (A) and parallel to the growth direction (B);

FIG. 6A shows the fracture toughness of Si—CrSi₂ rotationally cast samples as a function of thermal treatment as well as treatment in brine solution for extended periods (4-6 months) of time compared to investment cast Si—CrSi₂ samples and silicon;

FIG. 6B shows fracture toughness as a function of average particle size in the parallel direction of crack growth in the chevron notch bend test;

FIGS. 7A-7D show optical microscope images of the resulting wear track after testing of Si—CrSi₂ rotationally cast materials, with a box indicating the observed neck in the wear track (FIGS. 7A-7B); within the region of reduced wear a normal eutectic microstructure was observed with fine CrSi₂ precipitates embedded in the matrix of Si (FIG. 7C); the 3D optical interferometer image (FIG. 7D) of this necked region of the sample clearly indicates the reduction in wear at this normal eutectic microstructure;

FIG. 8 shows internal mold temperature as a function of time during rotational solidification;

FIGS. 9A-9F show scanning electron microscope (SEM) images of the microstructure sections a, b and c of the Si—CoSi₂ castings, where the scale bars shown are 100 microns;

FIGS. 10A-10B show temperature as a function of time for the interior and exterior of the mold after pouring of the melt for three different castings;

FIGS. 11A-11F show SEM images of the microstructure of various regions of an 11.25-in diameter casting, where the scale bars shown are 100 μm;

FIGS. 12A-12F show SEM images of the microstructure of various regions of a 19-in diameter casting, where the scale bars shown are 100 μm;

FIG. 13 shows fracture toughness measured for sections of the 11.25-in (Sample B) and 19-in diameter (Sample C) castings;

FIG. 14 shows the percent Si for sections of the 11.25-in (Sample B) and 19-in diameter (Sample C) castings;

FIG. 15 shows wear volume measured for the diameter variation study in the Si—CrSi₂ eutectic prepared by rotational casting, where the 11.25-in diameter and the 19-in diameter samples were divided into sections a, b, and c according to the diagram in FIG. 14;

FIG. 16 shows the influence of mold liner material on fracture toughness for Samples E, F and H;

FIG. 17 shows wear volume measured in samples of Si—CrSi₂ prepared by rotational casting with SiC (Sample E) and Graphoil lined molds (Samples F and H), where the XC designation reflects the wear properties of the cross sectioned samples with grain structure perpendicular to the growth direction;

FIG. 18 shows flexure strength of several Si—CrSi₂ rotational casting sections with 11.25-in diameter and 19-in diameter and mold coatings including SiC and Graphoil.

### DETAILED DESCRIPTION

It is noted that the terms “comprising,” “including” and “having” are used interchangeably throughout the specification and claims as open-ended transitional terms that cover the expressly recited subject matter alone or in combination with unrecited subject matter.

In previous demonstrations of silicon eutectic alloys prepared by other casting methods, only a modest improvement in fracture toughness (about 2 MPa·m^{1/2}) compared to silicon itself (about 0.8 MPa·m^{1/2}) was achieved. It is demonstrated here that silicon eutectic alloy compositions prepared by rotational casting may achieve a fracture toughness over 3 times higher than that of investment cast alloys due to a desirable microstructure of oriented, high aspect ratio eutectic structures. The alloy compositions described here may also exhibit other advantageous properties, including good wear- and corrosion-resistance

The silicon eutectic alloy compositions prepared by rotational casting comprise a body comprising a eutectic alloy including silicon, one or more metallic elements M, and a eutectic aggregation of a first phase comprising silicon and a second phase of formula MSi₂, where the second phase is a disilicide phase. The first phase, which can be referred to as a “silicon-containing phase,” may be an elemental silicon phase or an intermetallic compound phase.

When the first phase of the eutectic aggregation is an elemental silicon phase, the first phase comprises silicon in the form of crystalline silicon and/or amorphous silicon. When the first phase is an intermetallic compound phase, the first phase includes silicon and the metallic element(s) M and has the formula MₓSi_{y}, where x and y are integers. Generally, the intermetallic compound phase is different from the disilicide phase (the second phase), and thus x is not 1 and y is not 2.

According to one embodiment, one of the first and second phases of the eutectic aggregation comprises one or more colonies of substantially aligned high aspect ratio structures, and the body comprises a fracture toughness of at least about 3.2 MPa·m^{1/2}. The fracture toughness may also be at least about 6 MPa·m^{1/2} and may not exceed 25 MPa·m^{1/2}.

According to another embodiment, the body is symmetric about a longitudinal axis, and one of the first and second phases of the eutectic aggregation comprises high aspect ratio structures oriented along a radial direction with respect to the longitudinal axis. In addition, the body may comprise a fracture toughness of at least about 3.2 MPa·m^{1/2}. The fracture toughness may also be at least about 6 MPa·m^{1/2}, or at least about 7.5 MPa·m^{1/2}, and may not exceed 25 MPa·m^{1/2}.

The body may further comprise a wear volume of no more than about 4×10⁸ μm³, as determined according to American Society of Testing and Materials (ASTM) G133. A larger wear volume indicates a lower wear resistance.

Before describing the inventive process in detail, eutectic reactions and alloys are discussed.

### Eutectic Reactions and Si Eutectic Alloys

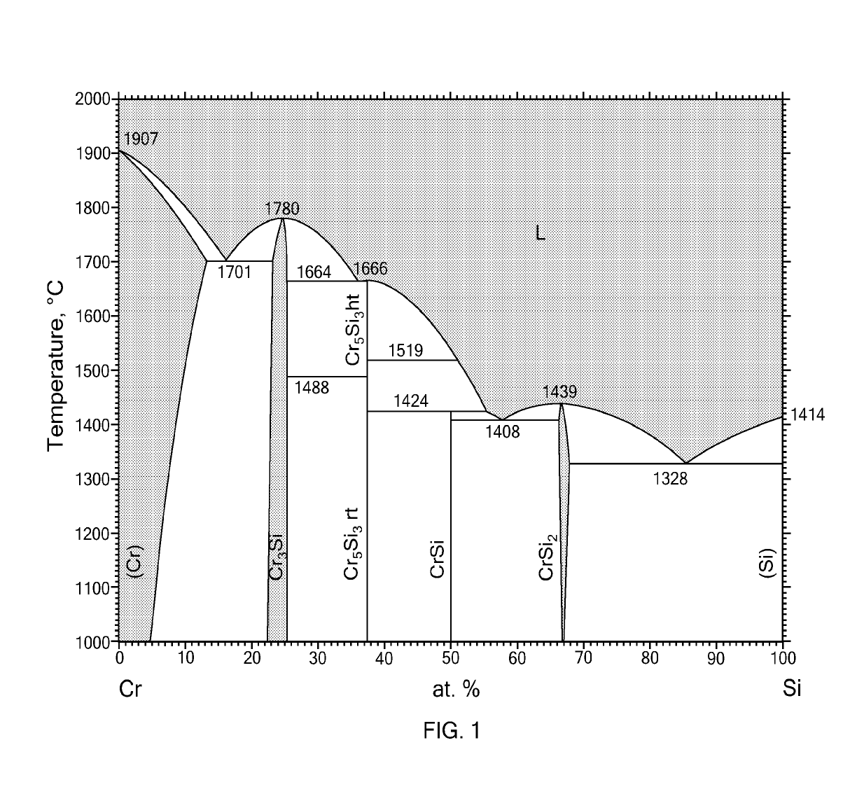

Referring to the exemplary phase diagram of FIG. 1, a eutectic reaction of the elements Si and M can be described as follows:

L [symbol] Si+MSi₂, or (1)

L [symbol] MₓSi_{y}+MSi₂, (2)

where a liquid phase (L) and two solid phases (e.g., Si and MSi₂ as in (1) or MₓSi_{y} and MSi₂ as in (2)) exist in equilibrium at a eutectic composition and the corresponding eutectic temperature. In the case of a binary eutectic alloy, the eutectic composition and eutectic temperature define an invariant point (or eutectic point). A liquid having the eutectic composition undergoes eutectic solidification upon cooling through the eutectic temperature to form a eutectic alloy composed of a eutectic aggregation of solid phases. Eutectic alloys at the eutectic composition melt at a lower temperature than do the elemental or compound constituents and any other compositions thereof (“eutectic” is derived from the Greek word “eutektos” which means “easily melted”).

In the case of a multicomponent eutectic alloy including two or more metallic elements M that each form a silicide, a eutectic boundary curve may be defined between multiple invariant points. For example, in the case of a ternary eutectic alloy including at least 50 at. % Si and two metallic elements (M=Mₐ,M_{b}) that undergoes reaction (1) above, the eutectic boundary curve joins two binary eutectic points, one defined by Si and MₐSi₂ and the other defined by Si and M_{b}Si₂. A liquid having a composition on the eutectic boundary curve undergoes eutectic solidification to form a eutectic alloy upon cooling.

The solid phases (e.g., Si and MSi₂ or MₓSi_{y} and MSi₂) that form upon cooling through the eutectic temperature at the eutectic composition define a eutectic aggregation having a morphology that depends on the solidification process. The eutectic aggregation may have a lamellar morphology including alternating layers of the solid phases, which may be referred to as matrix and reinforcement phases, depending on their respective volume fractions, where the reinforcement phase is present at a lower volume fraction than the matrix phase. In other words, the reinforcement phase is present at a volume fraction of less than 0.5. The reinforcement phase may comprise discrete eutectic structures, whereas the matrix phase may be substantially continuous. For example, the eutectic aggregation may include a reinforcement phase of rod-like, plate-like, acicular and/or globular structures dispersed in a substantially continuous matrix phase. Such eutectic structures may be referred to as “reinforcement phase structures.”

The reinforcement phase structures in the eutectic aggregation may further be referred to as high aspect ratio structures when at least one dimension (e.g., length) exceeds another dimension (e.g., width, thickness, diameter) by a factor of by a factor of 2 or more. Aspect ratios of reinforcement phase structures may be determined by optical or electron microscopy using standard measurement and image analysis software. The solidification process may be controlled to form and align high aspect ratio structures in the matrix phase. For example, when the eutectic alloy is produced by a directional solidification process, it is possible to align a plurality of the high aspect ratio structures along the direction of solidification, as shown for example in FIG. 2, which shows an optical microscope image of rod-like structures aligned perpendicular to the surface of an exemplary Si—CrSi₂ eutectic alloy sample (and viewed end-on in the image).

The reinforcement phase structures may be spaced apart from each other by an average characteristic spacing λ of 0.5 to 2 times the average lateral dimension of the structures. For example, for rod-like structures comprising an average diameter of from about 1 micron to about 50 microns, the average characteristic spacing λ may be from about 500 nm to about 100 microns. In the case of smaller reinforcement phase structures (e.g., smaller diameter rods or smaller particles having an average lateral dimension in the range of from about 1 micron to about 5 microns), the average characteristic spacing λ may range from about 0.5 micron to about 10 microns, or from about 4 microns to about 6 microns. An average length of the reinforcement phase structures may range from about 10 microns to about 1000 microns, and more typically from about 100 microns to about 500 microns.

Generally, the terms “anomalous” or “irregular” and “normal” or “regular” may be used to describe the degree of uniformity of the eutectic aggregation, where at or near extremes of uniformity, anomalous or irregular eutectic structures are randomly oriented and/or nonuniform in size, and normal or regular eutectic structures exhibit a substantial degree of alignment and/or size uniformity. A “substantial degree” of alignment (or size uniformity) refers to a configuration in which at least about 50% of the eutectic structures are aligned and/or of the same size. Preferably, at least about 80% of the eutectic structures are aligned and/or of the same size. For example, a normal eutectic aggregation may include silicide rods of a given width or diameter embedded in a silicon phase in a configuration in which about 90% of the silicide rods are aligned. The silicide rods of the eutectic aggregation may be arranged in a single “colony” or in a plurality of colonies throughout the silicon matrix, where each colony includes rods of having a substantial degree of alignment. The phrases or terms “substantially aligned,” “substantially parallel,” and “oriented,” when used in reference to the reinforcement phase structures, may be taken to have the same meaning as “having a substantial degree of alignment.”

The eutectic alloys described here may be composed entirely or in part of the eutectic aggregation of silicon-containing and disilicide phases. When the eutectic alloy includes silicon and the metallic element(s) M at a eutectic concentration ratio thereof (i.e., at a eutectic composition of the alloy), then 100 volume percent (vol. %) of the eutectic alloy comprises the eutectic aggregation.

If, on the other hand, the eutectic alloy includes silicon and the metallic element(s) M at a hypoeutectic concentration ratio thereof, where the concentration of silicon is less than a eutectic concentration (with a lower limit of >0 at. % silicon), then less than 100 vol. % of the eutectic alloy comprises the eutectic aggregation. This is due to the formation of a non-eutectic phase prior to formation of the eutectic aggregation during cooling.

Similarly, if the eutectic alloy includes silicon and the metallic element(s) M at a hypereutectic concentration ratio thereof, where the concentration of silicon exceeds a eutectic concentration (with an upper limit of <100 at. % silicon), then less than 100 vol. % of the eutectic alloy may include the eutectic aggregation due to the formation of a non-eutectic phase prior to the eutectic aggregation during cooling.

Depending on the concentration ratio of the silicon and the metallic element(s) M, at least about 70 vol. %, at least about 80 vol. %, or at least about 90 vol. % of the eutectic alloy may comprise the eutectic aggregation.

The eutectic alloy described herein includes greater than 0 at. % Si, e.g., at least about 50 at. % Si. The alloy may also include at least about 60 at. % Si, at least about 70 at. % Si, at least about 80 at. % Si, or at least about 90 at. % Si; and at most about 90 at. % Si, alternatively at most about 80 at. % Si, alternatively at most about 70 at. % Si, alternatively at most about 60 at. % Si; alternatively any usable combination of the foregoing at least and at most values, depending on the metallic element(s) M and whether a eutectic, hypoeutectic, or hypereutectic concentration ratio of the elements is employed. The eutectic alloy includes a total of 100 at. % of silicon, the one or more metallic elements M, and any residual impurity elements.

The silicon-containing phase may be an elemental silicon phase including crystalline silicon and/or amorphous silicon, as mentioned previously. Crystalline silicon may have a diamond cubic crystal structure, and the grain size or crystallite size may lie in the range of from about 200 nanometers (nm) to about 5 millimeters (mm) or more. Typically, the grain size is from about 1 μm to about 100 μm.

The metallic element(s) M may be one or more of chromium, cobalt, hafnium, molybdenum, nickel, niobium, rhenium, tantalum, titanium, tungsten, vanadium, and zirconium. When present, the intermetallic compound phase MₓSi_{y} may have a formula selected from MSi and M₅Si₃, such as CrSi, CoSi, TiSi, NiSi, V₅Si₃, Nb₅Si₃, Ta₅Si₃, Mo₅Si₃, and W₅Si₃. The disilicide phase MSi₂ may have a crystal structure selected from among the cubic C1, tetragonal C11_{b}, hexagonal C40, orthorhombic C49, and orthorhombic C54 structures. The crystal structure may be cubic C1. The crystal structure may be tetragonal C11_{b}. The crystal structure may be hexagonal C40. The crystal structure may be orthorhombic C49. The crystal structure may be orthorhombic C54. Each of cobalt disilicide (CoSi₂) and nickel disilicide (NiSi₂) has the cubic Cl crystal structure; each of molybdenum disilicide (MoSi₂), rhenium disilicide (ReSi₂), and tungsten disilicide (WSi₂) has the tetragonal C11b crystal structure; each of hafnium disilicide (HfSi₂) and zirconium disilicide (ZrSi₂) has the orthorhombic C49 crystal structure; and each of chromium disilicide (CrSi₂), niobium disilicide (NbSi₂), tantalum disilicide (TaSi₂), and vanadium disilicide (VSi₂) has the hexagonal C40 structure. Titanium disilicide (TiSi₂) has the orthorhombic C54 crystal structure.

Tables 1 and 2 below provide a listing of reactions for exemplary binary Si eutectic systems, the corresponding invariant points, and information about the silicide phase that is formed in the reactions. Table 1 covers eutectic reactions that lead to an elemental silicon phase and a disilicide phase, and Table 2 covers the eutectic reactions that lead to a disilicide phase and an intermetallic compound phase other than a disilicide phase.

The theoretical volume fractions of MSi₂ were derived using the following approach, which is shown for the particular case of the Si—Cr system but may be generalized to any of the eutectic systems to arrive at the theoretical volume fractions set forth in Tables 1 and 2.

From the phase diagram, it is known that the Si—CrSi₂ eutectic point is at 85.5 at. % Si and 14.5% at. % Cr. The weight percent is calculated by the following:

$$\begin{matrix}\begin{matrix}\frac{0.855 * 28.086 g \text{/} mol}{( 0.855 * \frac{28.086 g}{mol} ) + ( 0.145 * \frac{51.996 g}{mol} )} = 0.76 * 100 \\ = 76 wt . \% Si\end{matrix} & ( 1 ) \\ \begin{matrix}\frac{0.145 * 51.996 g \text{/} mol}{( 0.855 * \frac{28.086 g}{mol} ) + ( 0.145 * \frac{51.996 g}{mol} )} = 0.24 * 100 \\ = 24 wt . \% Cr\end{matrix} & ( 2 )\end{matrix}$$

Assuming a 100 g sample:

$$\begin{matrix}\frac{24 g}{51.9 g \text{/} mol} = 0.462 mol Cr & ( 3 ) \\ \frac{76 g}{28.086 g \text{/} mol} = 2.71 mol Si & ( 4 )\end{matrix}$$

During the reaction CrSi₂ is formed by consuming all of the Cr metal, thus there is 0.443 mol of CrSi₂. The molecular weight of CrSi₂ is 108.168 g/mol.

$$\begin{matrix}0.462 mol {CrSi}_{2} * 108.168 \frac{g}{mol} = 49.9 g {CrSi}_{2} & ( 5 ) \\ ( 2.71 mol - ( 2 * 0.462 mol ) ) * 28.086 \frac{g}{mol} = 50.1 g Si & ( 6 )\end{matrix}$$

The volume of each phase is calculated by dividing by the density of the materials:

$$\begin{matrix}\frac{49.9 g {CrSi}_{2}}{5.01 \frac{g}{cc}} = 9.96 cc & ( 7 ) \\ \frac{50.1 g Si}{2.33 \frac{g}{cc}} = 21.5 cc & ( 8 )\end{matrix}$$

The theoretical volume fraction of each phase is the volume of each phase divided by the total volume:

$$\begin{matrix}\frac{9.96 cc}{9.96 cc + 21.5 cc} = 0.316 = Volume Fraction {CrSi}_{2} & ( 9 ) \\ \frac{21.5 cc}{9.96 cc + 21.5 cc} = 0.683 = Volume Fraction Si & ( 10 )\end{matrix}$$

TABLE 1
Exemplary Eutectic Reactions L → Si + MSi₂.

| | Invariant or Eutectic Point | | MSi₂ | |
|---|---|---|---|---|
| | Compo- | Temper- | (vol. | |
| Eutectic | sition | ature | frac- | MSi₂ |
| Reaction | (wt. % Si) | (° C.) | tion) | (wt. % Si) |
| L → Si + MoSi₂ | 93.5 | 1400 | 0.04 | 37 |
| L → Si + WSi₂ | 93.8 | 1390 | 0.02 | 23.4 |
| L → Si + VSi₂ | 94.7 | 1400 | 0.06 | 52.5 |
| L → Si + NbSi₂ | 93.7 | 1395 | 0.045 | 37.7 |
| L → Si + TaSi₂ | 80.6 | 1395 | 0.08 | 23.7 |
| L → Si + CrSi₂ | 76.0 | 1328 | 0.316 | 52.9 |
| L → Si + TiSi₂ | 75.5 | 1330 | 0.472 | 54 |
| L → Si + CoSi₂ | 62.1 | 1259 | 0.570 | 48.8 |

TABLE 2
Exemplary Eutectic Reactions L → MₓSi_{y} + MSi₂

| | Invariant or Eutectic Point | | MSi₂ | |
|---|---|---|---|---|
| | Compo- | Temper- | (vol. | |
| Eutectic | sition | ature | frac- | MSi₂ |
| Reaction | (wt. % Si) | (° C.) | tion) | (wt. % Si) |
| L → Mo₅Si₃ + MoSi₂ | 25.6 | 1900 | 0.511 | 37 |
| L → W₅Si₃ + WSi₂ | 18.2 | 2010 | 0.716 | 23.4 |
| L → V₅Si₃ + VSi₂ | 44.2 | 1640 | 0.743 | 52.5 |
| L → Nb₅Si₃ + NbSi₂ | 28.6 | 1887 | 0.623 | 37.7 |
| L → Ta₅Si₃ + TaSi₂ | 19.8 | 1980 | 0.791 | 23.7 |
| L → CrSi + CrSi₂ | 41.7 | 1408 | 0.412 | 52.9 |
| L → TiSi + TiSi₂ | 51.0 | 1473 | 0.841 | 54 |
| L → CoSi + CoSi₂ | 43.5 | 1314 | 0.738 | 48.8 |
| L → NiSi + NiSi₂ | 38.04 | 949 | 0.390 | 48.9 |

In the case where the eutectic alloy is a multicomponent eutectic alloy including two or more elements M, it may be advantageous for each of the disilicides (MₐSi₂ and M_{b}Si₂) or intermetallic compounds (MSi or M₅Si₃) to have the same crystal structure and be mutually soluble so as to form in essence a single reinforcement phase (e.g., (Mₐ,M_{b})Si₂, (Mₐ,M_{b})Si, (Mₐ,M_{b})₅Si₃). For example, in the case of the disilicide phase, Mₐ and M_{b} may be Co and Ni, or Mo and Re. It is also envisioned that a multicomponent eutectic alloy may include two or more metallic elements M that form disilicides or intermetallic compounds with different crystal structures, such that the multicomponent eutectic alloy includes two or more insoluble silicide phases. For example, Mₐ and M_{b} may be Cr and Co, or Cr and Ni, which may form insoluble disilicide phases. Accordingly, exemplary ternary eutectic alloys may include two metallic elements M, where M=Mₐ, M_{b}, as set forth in Table 3:

TABLE 3
Exemplary Combinations of Metallic
Elements in Ternary Si Eutectic Alloys
M

| Mₐ | M_{b} |
|---|---|
| Co | Ni |
| Mo | Re |
| Mo | W |
| Re | W |
| Hf | Zr |
| Cr | Nb |
| Cr | Ta |
| Cr | V |
| Nb | Ta |
| Nb | V |
| Ta | V |
| Cr | Co |
| Cr | Ni |

### Fabrication of Silicon Eutectic Alloys

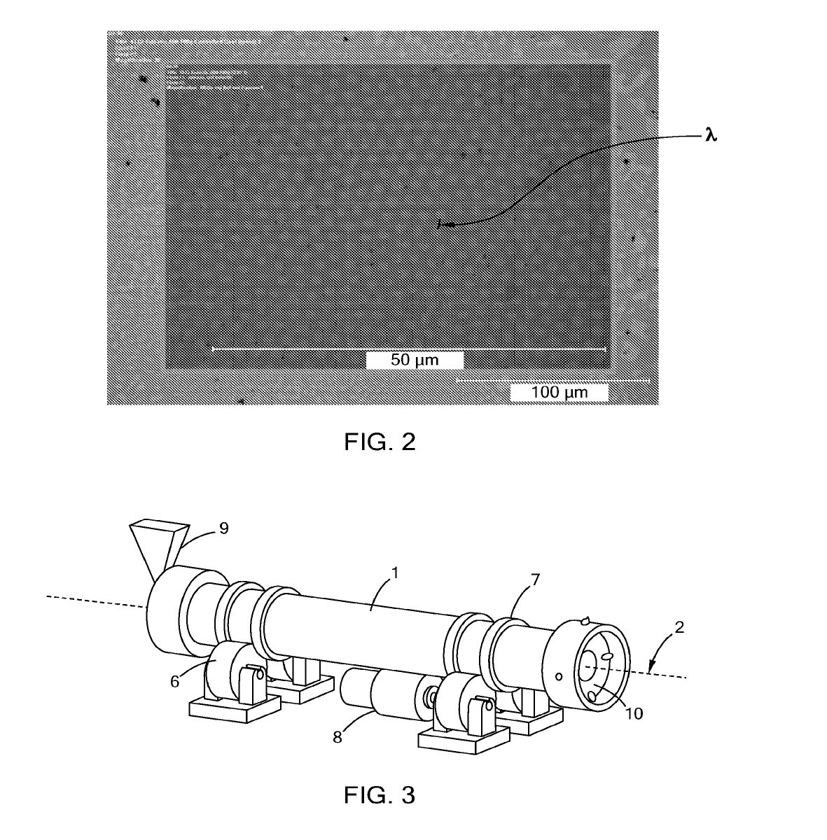

The rotational casting method set forth herein may be carried out using an apparatus such as that shown in FIG. 3, which provides a schematic of an exemplary rotational casting machine. The method includes melting together silicon and one or more metallic elements M to form a eutectic alloy melt comprising silicon and the one or more metallic elements M. A mold 1, which is symmetric about the longitudinal axis 2 shown in FIG. 3 and which contains the eutectic alloy melt, is rotated about the axis at a speed sufficient to form a rotating volume of the eutectic alloy melt in contact with an inner surface of the mold 1.

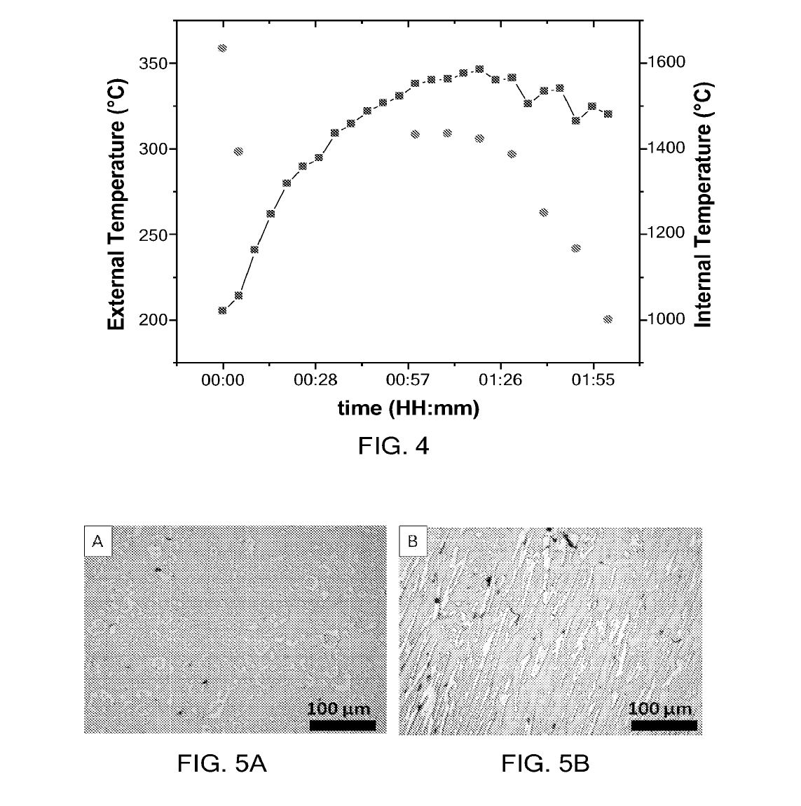

As the mold is rotated, heat is directionally removed from the rotating volume to effect directional solidification of the eutectic alloy melt. FIG. 4 shows an exemplary thermal profile obtained during rotational casting from within the mold (diamonds) and outside the mold (squares). Accordingly, a eutectic alloy composition including silicon, one or more metallic elements M, and a eutectic aggregation of a first phase comprising silicon and a second phase of formula MSi₂, the second phase being a disilicide phase, may be formed.

Directional solidification of the eutectic alloy melt is driven by motion of a solidification front through the rotating volume, where the solidification front defines an interface between the (liquid) eutectic alloy melt and the (solidified) eutectic alloy composition. The rate of directional solidification thus corresponds to the speed at which the solidification front travels through the rotating volume, which in turn depends on the rate of heat removal. The speed of the solidification front may be from about 0.1 millimeters per minute (mm/min) to about 100 mm/min. The speed may also be from about 0.1 mm/min to about 50 mm/min, from about 0.5 mm/min to about 10 mm/min, from about 1 mm/min to about 5 mm/min, or from about 0.5 mm/min to about 1.5 mm/min.

The solidification front generally travels in a direction away from the inner surface of the mold such that solidification occurs first at a portion of the rotating volume in contact with the inner surface. The solidification front may travel away from the inner surface in a normal direction with respect to the inner surface and/or in a radial direction with respect to the longitudinal axis of the mold.

An outer surface of the mold, which is separated from the inner surface by a wall of the mold, may be actively cooled to enhance heat removal from the rotating volume and promote motion of the solidification front away from the inner surface. For example, the outer surface of the mold may be cooled at a rate of about 50 degrees Celsius per minute (° C./min) or higher, about 100° C./min or higher, about 200° C./min or higher, or about 300° C./min or higher; alternatively, the outer surface of the mold may be cooled at a rate of no more than about 500° C./min, alternatively no more than about 400° C./min, alternatively no more than about 300° C./min, alternatively any usable combination of the preceding lower and upper values. The active cooling may be carried out by, for example, by water cooling, cooling with air or forced air or by modification of the mold surface to tune the thermal diffusivity to maintain control of thermal gradients. This could also include active cooling of the gas flow through the center of the casting to allow inside-out or outside-in solidification. In other words, it is also contemplated that the solidification front may travel from a central region of the mold in an outward radial direction toward the inner surface of the mold.

As a consequence of actively or passively cooling the outer surface of the mold, heat may be removed from the rotating volume of the eutectic alloy melt at a rate of about 25° C./min or higher, about 50° C./min or higher, about 100° C./min or higher, or about 200° C./min or higher; alternatively, the outer surface of the mold may be cooled at a rate of no more than about 400° C./min, alternatively no more than about 300° C./min, alternatively no more than about 200° C./min, alternatively any usable combination of the preceding lower and upper values.

The speed of rotation of the mold is preferably sufficient to create a rotating volume of the eutectic alloy melt in contact with the inner surface of the mold. Accordingly, the speed of rotation of the mold may be selected so as to generate an equivalent gravitational acceleration (G-force) of from about 9.8 meters per second squared (m/s²) to about 3,920 m/s² (i.e., from about 1 G to about 400 G, where G=9.8 m/s²). The G-force may also be from about 29.4 m/s² to about 1176 m/s² (i.e., from about 3 G to about 120 G). If the rotational speed of the mold about the longitudinal axis and the temperature and fluidity of the eutectic alloy melt are adequate, the rotating volume may be uniformly distributed over the inner surface of the mold.

Exemplary rotational speeds are from 100 rotations per minute (rpm) to about 1000 rpm. A preferred range is from about 600 rpm to about 800 rpm. The rotational speed may be constant or variable. For example, the rotational speed may initially be at a low value while the eutectic alloy melt is being introduced into the mold cavity and then rapidly increased to a desired higher value after that. In some cases, the rotational speed may be zero rpm (i.e., the mold may be stationary or at a rotational speed of from >0 rpm to <20 rpm) when the eutectic alloy melt is introduced into the mold cavity.

To prepare the eutectic alloy melt, the silicon and the one or more elements M may be heated at a temperature at or above the eutectic temperature of the eutectic alloy composition to be formed. For example, the melting together may entail heating the silicon and the metallic element M to a temperature at or above the eutectic temperature and below a superheat temperature of the eutectic alloy component. Alternatively, the melting together may entail heating the silicon and the metallic element M to a temperature at or above a superheat temperature of the eutectic alloy component.

The superheat temperature is preferably sufficiently far above the eutectic temperature to promote rapid diffusion and permit a homogeneous melt to be formed without an excessively long hold time (e.g., without a hold time greater than about 60 min). Attaining a homogeneous melt prior to solidification is particularly important for alloys at the eutectic composition so that the entire volume of the melt undergoes eutectic solidification upon cooling. If local regions of the eutectic alloy melt include deviations from the eutectic composition, then these local regions may experience precipitation and coarsening of undesirable non-eutectic phases during solidification.

Accordingly, it is advantageous for the superheat temperature to be at least about 50° C. above the eutectic temperature, at least about 100° C. above the eutectic temperature, at least about 150° C. above the eutectic temperature, at least about 200° C. above the eutectic temperature, at least about 250° C. above the eutectic temperature, or at least about 300° C. above the eutectic temperature for the eutectic alloy. The superheat temperature may also be at most about 500° C. above the eutectic temperature, alternatively at most about 400° C. above the eutectic temperature, alternatively at most about 300° C. above the eutectic temperature, alternatively at most about 200° C. above the eutectic temperature; alternatively any usable combination of the foregoing at least and at most values. For example, for the Si—CrSi₂ system, the superheat temperature may lie in the range of from about 1400° C. to about 1600° C., which is from about 65° C. to about 265° C. above the eutectic temperature of the Si-Cr eutectic system.

The melting together of the silicon and the one or more elements M may take place outside the mold in, for example, an induction furnace, and the eutectic alloy melt may then be transferred into the mold cavity using a heated transfer device, such as a ladle, an angled nozzle spout, a straight nozzle spout, or a pouring boot fabricated from a refractory material that does not react with the eutectic alloy melt. The eutectic alloy melt may be introduced at one end of the mold, from both ends of the mold, from the interior of the mold (via a lance or other distributor), or combinations thereof. When the eutectic alloy melt is introduced into a mold cavity that is already rotating, it is advantageously introduced in a manner allowing its initial velocity to be in the direction of the mold's rotation to facilitate obtaining a uniform distribution of the melt over the inner surface.

Typically, the inner surface of the mold is preheated at a preheat temperature before introducing the eutectic alloy melt into the mold cavity (or before introducing the silicon and the one or more elements M into the mold cavity if the eutectic alloy melt is prepared in the mold). The preheat temperature of the inner surface may be, for example, from about 50° C. to about 1600° C., or more typically from about 1000° C. to about 1600° C. It may be advantageous for the inner mold surface to be preheated to a temperature that is above the eutectic temperature of the eutectic alloy composition to be formed. In some embodiments, the outer mold surface may also be pre-heated. For example, the outer mold surface may be preheated to a temperature of from about 30° C. to about 350° C. and the inner mold surface may be preheated to a temperature of from about 1100° C. to about 1550° C.

The mold may be heated by any of a number of heating devices known in the art, and the devices used for heating the inner and outer mold surfaces may be the same or different. Examples of suitable heating devices include, for example, a hydrogen/oxygen torch, an oven, a fuel gas heater/burner, an electric heater, or combinations thereof.

Introduction of the eutectic alloy melt into the mold cavity and the rotational casting process itself may be carried out in a vacuum environment (e.g., at a pressure >0 Torr and lower than 10⁻⁴ Torr (about 10⁻² Pa or lower) and preferably lower than 10⁻⁵ Torr (about 10⁻³ Pa or lower)) or in a nonreactive (e.g., inert gas) gas environment. The eutectic alloy melt may also be filtered to remove impurities prior to, or concurrently with, its introduction into the mold. Suitable filters may include, for example, silicon carbide, aluminum oxide, and/or aluminum oxide/graphite ceramic filters.

The mold used for rotational casting may have a cylindrical shape, a conical shape, a tapered shape, or another longitudinally symmetric shape. The mold may also have a tube-like shape where the mold cavity surrounds a hollow bore symmetric about the longitudinal axis. The mold may be oriented such that the longitudinal axis is horizontal or non-horizontal (e.g., vertical), and may be fabricated from a material suitable for high temperature exposure. Examples of suitable materials for the mold include, but are not limited to, cast iron, steel alloys, molybdenum, titanium, tantalum, tungsten, ceramics and other refractory materials. For example, a steel mold having a cylindrical shape may be utilized for rotational casting while maintained in a substantially horizontal orientation. One or more end-caps may be utilized with the mold to prevent leakage of the eutectic alloy melt during processing.

The inner mold surface may include a layer of a non-reactive refractory material to provide an interface (e.g., a thermal interface) between the eutectic alloy melt and the mold material and to facilitate mold release after casting. Examples of suitable refractory materials include, for example, silica, silicon carbide, silicon nitride, boron nitride, alumina, magnesia, alumina-silicate, and combinations thereof. In some embodiments, the refractory material comprises at least 1% weight percent (wt. %) of silica. In some embodiments, the refractory material comprises from about 10 wt. % silica to about 100 wt. % silica. For example, good results may be obtained with a refractory material comprising from about 30 wt. % silica to about 98 wt. % silica. The refractory material is advantageously uniformly applied to the inner surface of the mold and may be applied in any suitable manner including, for example, spray coating or hand loading into the spinning mold.

In addition to or in lieu of the layer of non-reactive refractory material (“refractory liner”), the inner mold surface may include a layer of a non-reactive thermally conductive material (“conductive liner”), such as graphite, silicon carbide, or glassy carbon. The term “non-reactive” means substantially inert with respect to the eutectic alloy melt. Advantageously, the conductive liner has a thermal conductivity of at least about 10 W/(m·K), and the thermal conductivity may also be at least about 100 W/(m·K). The conductive liner may take the form of a rolled foil or seamless sheet or tube that is bonded to or otherwise in secure contact with the inner mold surface (or, when present, the refractory liner). It has been found that the presence of the non-reactive conductive liner between the inner mold surface and the melt, or between the refractory liner and the melt, may lead to a melt having improved chemical homogeneity and fracture toughness, as discussed in the examples below.

Other details about rotational casting in general may be found in WO 2011/068736, “Rotational Casting Process,” published on Jun. 9, 2011, and which is hereby incorporated by reference in its entirety.

The eutectic alloy melt may include silicon and one or more metallic elements M at a eutectic concentration ratio thereof. Alternatively, the eutectic alloy melt may include silicon and one or more metallic elements M at a hypoeutectic concentration ratio thereof, where the hypoeutectic concentration ratio has a lower limit based on a silicon concentration of >0 at. % Si. It is also contemplated that the eutectic alloy melt may include silicon and the one or more metallic elements M at a hypereutectic concentration ratio thereof, where the hypereutectic concentration ratio has an upper limit based on a silicon concentration of <100 at. % Si.

During casting, high aspect ratio eutectic structures of either the first phase or the second phase of the eutectic aggregation may be oriented substantially parallel to the direction of travel of the solidification front, which may be the normal (perpendicular) direction with respect to the inner surface of the mold and/or the radial direction with respect to the longitudinal axis. The high aspect ratio structures that form during solidification may have an average lateral dimension of from about 1 micron to about 50 microns, and an average length ranging from about 10 microns to 1 mm, or from about 100 microns to about 800 microns. The silicon rich eutectic alloy composition formed by rotational casting of the eutectic alloy melt may further have any of the attributes and chemistries described previously.

It may be possible to control the size of the high aspect ratio structures formed during solidification by controlling the rate of heat removal (cooling rate). For a rotational casting of a given size, this may be achieved by altering the cooling rate. For example, the mold may be actively cooled using a flow of a liquid (e.g., water flowing through a jacket surrounding the mold) or a gas to more effectively remove heat from the casting, as discussed above. By increasing the cooling rate to solidify the casting more rapidly, the size of the high aspect ratio structures formed in the solidified casting may be decreased. Inversely, by decreasing the cooling rate to solidify the casting more slowly, the size of the high aspect ratio structures formed may be increased.

It may also be possible to manipulate the size of the high aspect ratio structures formed upon solidification by altering the size (e.g., diameter) of the casting. In the case of two passively cooled castings of different diameters, heat can be extracted more quickly from the smaller diameter casting, which has a smaller volume to cool, and thus the microstructure of the smaller diameter casting may be refined compared to the larger diameter casting. This is discussed in Example 7 below.

An exemplary rotational casting process for preparing a Si—CrSi₂ eutectic alloy ingot is described in detail in Example 1 below. Following solidification, the ingot was cut and analyzed for microstructure as described in Example 2. Also, fracture toughness and wear behavior were investigated in comparison to investment cast samples and as a function of environmental treatment, as described in Examples 3 and 4. The Si—CrSi₂ alloy samples prepared were treated in a brine bath, heat treated, or both brine and heat treated for 6 months, as discussed in Example 5.

The results of two subsequent rotational casting trials are described in Examples 6 through 8. Other compositions besides Si—CrSi₂ (e.g., Si—CoSi₂) and process parameters were investigated, including diameter of the casting and/or the presence of a conductive liner between the ceramic (refractory) liner of the inner wall of the mold and the melt. A summary of the alloys investigated is set forth in Table 4.

TABLE 4
Summary of Composition, Size and Density of Si Eutectic Alloys of
Examples 1-8

| | | Com- | | Di- | Alloy | |
|---|---|---|---|---|---|---|
| Sam- | | position | Amount | ameter | Density | |
| ple | Alloy | (wt. %) | (lbs) | (in) | (g/cc) | Mold Liner |
| A | Si—Cr | 76/24 | ^{~}200 | ^{~}19 | 3.67 | High purity |
| | | | | | | silica |
| B | Si—Cr | 76/24 | 157 | 11.25 | 3.67 | High purity |
| | | | | | | silica |
| C | Si—Cr | 76/24 | 351 | 19 | 3.67 | High purity |
| | | | | | | silica |
| D | Si—Co | 62.4/37.86 | 313 | 15 | 3.83 | High purity |
| | | | | | | silica |
| E | Si—Cr | 76/24 | 157 | 11.25 | 3.67 | SiC |
| F | Si—Cr | 76/24 | 110 | 10 | 3.67 | Graphite foil |
| G | Si—Cr | 76/24 | 26 | 6 | 3.67 | High purity |
| | | | | | | silica |
| H | Si—Cr | 76/24 | 110 | 11.75 | 3.67 | Graphite foil |

### Example 1

### Rotational Casting of a Si—CrSi₂ Eutectic Alloy Composition

An exemplary rotational casting run is described here for a Si—CrSi₂ eutectic alloy composition (sample A in Table 4).

A 90 kg batch, including 21.8 kg of chromium and the balance silicon, was melted in a 1000 lb induction furnace (Box InductoTherm) lined with a ceramic crucible (Engineered Ceramics Hycor model CP-2457) and sealed with a refractory top cap (Vesuvius Cercast 3000). During the melting process, the furnace was purged with argon by a liquid drip to reduce the formation of SiO gas and silicon dioxide.

The silicon eutectic melt was heated to 1524° C. prior to being poured into a refractory lined transfer ladle (Cercast 3000). The transfer ladle was preheated to 1600° C. using a propane/air fuel torch assembly. The temperature of the silicon eutectic melt in the transfer ladle was measured at 1520° C. prior to pouring into the rotational casting apparatus. Molten material from both the furnace and the transfer ladle was employed for elemental analysis to establish a baseline material composition.

A rotational casting apparatus (Centrifugal Casting Machine Co., model M-24-22-12-WC) was fitted with a refractory lined steel casting mold having nominal dimensions of 420 mm in diameter x 635 mm in length. The eutectic alloy casting produced in this experiment measured 372 mm in diameter×635 mm in length×74 mm in wall thickness.

Prior to rotationally casting the eutectic alloy melt, Advantage W5010 mold wash was sprayed onto the inner surface of the rotating mold to provide a base coating of approximately 1 mm in thickness. The steel mold was rotated at 58 rpm and was preheated to 175° C. using an external burner assembly. The mold was then sped up to 735 rpm and hand-loaded with a sufficient volume of Cercast 3000 refractory to centrifugally create a 19 mm-thick first refractory layer within the mold. The mold was then transferred into a heat treatment oven whereby the mold was maintained at 175° C. for an additional 4 hours before being allowed to slowly cool to ambient temperature.

Next, Vesuvius Surebond SDM 35 was hand loaded into the mold cavity and the mold was spun at 735 rpm to uniformly generate a 6 mm-thick second refractory layer on the first refractory layer. After 30 min of spinning, the mold assembly was stopped and allowed to air dry for 12 hours.

A propane/oxygen torch was used to preheat the mold inner refractory surface to 1315° C. The torch nozzle was positioned flush to the 100 mm opening in the end-cap and was directed into the mold and allowed to vent out the rear 100 mm opening in the opposing end-cap.

A transfer ladle, supported on a Challenger 2 model 3360 weigh scale device, was used transfer the eutectic alloy melt from the induction furnace to the rotational casting mold. The eutectic alloy melt was poured from the transfer ladle at 1520° C. into the refractory-coated mold as it rotated at a speed of 735 rpm.

Mold speed was maintained at 735 rpm for 4 minutes to allow for impurity and slag separation. The mold speed was then slowly reduced to a point in which the material visually appeared as pooling in the bottom of the spinning mold and droplets appeared to be slumping at the top of the mold (near raining point). Mold speed was measured as 140 rpm and was maintained for 30 minutes with only ambient air cooling. The mold speed was then increased to 735 rpm and was maintained for 63 minutes of directional solidification. An alumina ceramic rod was inserted through the 100 mm opening in the mold cap to verify that the core of the casting was still liquid. The experiment was concluded when the casting was visually deemed solid and the dip rod was unable to penetrate the inner surface of the casting.

Experimental temperature data were recorded for the mold outside temperature using a Fluke 65 infrared thermometer measurement instrument. Internal mold and ladle temperatures were measured using a model OS524 infrared thermometer (Omega Engineering, Inc., Stamford, Conn.). The rotational speed of the mold (in rpm) was measured using a photo/contact tachometer with built-in infrared thermometer (Extech Instruments, Nashua, N.H.). Eutectic alloy melt temperatures were measured using an immersion temperature sensor (Heraeus ElectroNite model).

After 100% solidification, the casting was allowed to spin for an additional 45 minutes to provide air-cooling to the mold prior to removal from the rotational casting apparatus. The mold and casting were then removed and allowed to cool slowly overnight.

A hydraulic press was used to extract the casting from the steel mold body. The refractory shell was separated and the casting was blasted with silica grit to remove remaining traces of refractory.

### Example 2

### Microstructure Analysis of Si—CrSi₂ Eutectic Alloys

The microstructure of the solidified eutectic alloy composition was characterized using optical and scanning electron microscopy after sectioning and careful polishing. Rotational cast samples were cut and polished in both the parallel and perpendicular direction to the eutectic growth direction. Several representative optical micrographs of the rotational cast eutectic alloy samples are shown in FIGS. 5A-5B. In the rotational cast material there is a rod-like structure that developed as a function of the directional cooling, with rods of 30-100 μm in diameter and several hundred microns in length. It is this aspect ratio that improves the toughness and can reinforce the material through fiber-pullout mechanisms that are not possible in structures without orientation. Both anomalous structures and also distinct regions of normal eutectic structures dispersed within the material are observed.

The mechanical properties of silicon eutectic alloys may be correlated to the microstructure of the cast materials. In eutectic solidification, faster cooling results in a refined microstructure resulting in a higher density of interfaces for reinforcement. Additionally, directional solidification, as observed in the rotational cast samples, gives rise to an oriented or substantially aligned microstructure significantly improving the fracture toughness in specific growth orientations. The rotational cast materials contain colonies of normal eutectic grains that are embedded in those of anomalous rod-like growth. Also present are core-shell rod like precipitates that could also improve toughness in this composite. A correlation exists in the silicon eutectic alloys between microstructure, processing conditions, and mechanical behavior.

### Example 3

### Fracture Toughness of Si—CrSi₂ Eutectic Alloys

The fracture toughness of rotational cast parts was measured using the chevron notch bend (CNB) test as specified in ASTM 1421. This test relies on the precise cutting of a notch in a bar shaped (3 mm×4 mm×40 mm) sample of material to provide a point of initiation of a crack for stable fracture. Because of the brittle nature of these materials, the failure during crack propagation is typically catastrophic, but can be mitigated by using the chevron notch bend test. Other methods exist for the measurement of fracture toughness; however, for brittle composite materials, the CNB is the standard test that allows for accurate measurement of toughness in composite materials with flat or rising R-curves. In addition to the samples of Si-rich eutectic alloys tested, two standard materials, namely SiC and silicon nitride (NIST SRM-2100), were tested and verify the method.

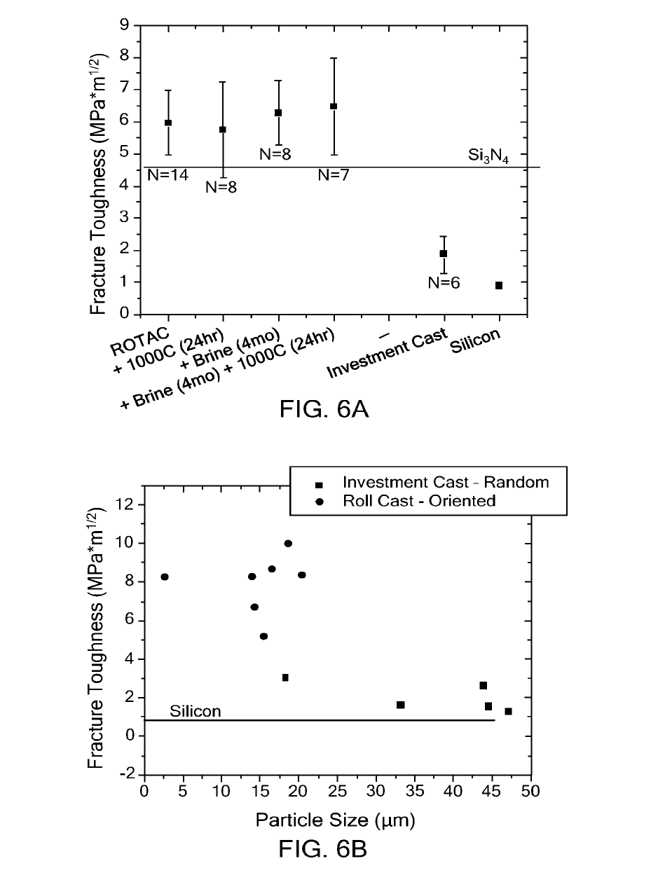

Referring to FIGS. 6A and 6B, the measured fracture toughness indicates that, while all samples of Si—CrSi₂ eutectic have improved toughness compared to silicon, the rotational cast sample has significantly improved toughness compared to the investment cast sample and even some engineered ceramic materials. It is likely that the improved toughness is due to the fiber-pullout mechanism of toughening in this sample while the investment cast samples only have the benefit of crack deflection at the interface of the disilicide phase. This is illustrated in FIG. 6B where the fracture toughness is displayed as a function of particle size. In the samples measured it is clear that the rotational cast samples have a higher toughness even for similarly sized particles. It is likely that the oriented growth has a larger impact on the toughness, because even for similar sizes of CrSi₂ precipitates, the oriented growth samples exhibit improved toughness.

### Example 4

### Wear Behavior of Si—CrSi₂ Eutectic Alloys

In addition to fracture toughness, the wear behavior of Si-alloys is particularly important in several applications, such as bearings and valves. The coefficient of friction and wear rate were measured using ASTM G133. In this test a WC ball is fixed in a reciprocating fixture loaded with a specified weight. During the test the ball abrades the surface of a flat polished sample. The wear track that develops during the erosion of material is then measured and used to calculate a wear constant. In addition to the wear constant the frictional force is measured during the test and used to calculate the coefficient of friction between a given set of materials. These quantities can be used to compare to other technical ceramics where wear is the critical performance parameter.

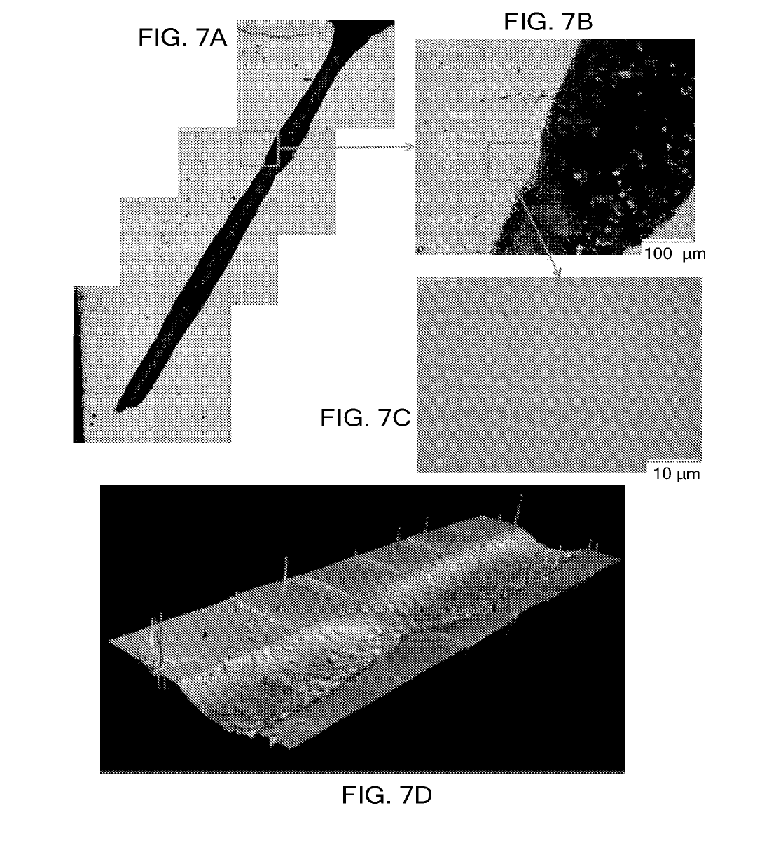

FIGS. 7A-7B show a wear scar from reciprocating wear tests of the rotational cast sample. Within the scar there is a significant neck in the wear track. When this neck was investigated further, it can be seen that neck morphology may be correlated with the presence of a colony of very fine oriented CrSi₂ eutectic structures (FIG. 7C). These normal eutectic structures have significantly reduced wear compared to the surrounding grains. Upon further magnification of the normal eutectic microstructure, a crack is visible and is a perfect demonstration of crack deflection at the interfaces between the silicide and the Si matrix (FIG. 7D). It is this crack deflection mechanism that toughens the material and gives rise to the significantly improved wear resistance in this region of the sample. It may be possible to obtain a larger fraction of oriented normal eutectic through careful control of the heat flows during solidification. When the cross sectional area of the scar in the region of normal eutectic was extrapolated, a wear volume of 2.36×10⁶ μm was calculated. This is comparable, and possibly even better, than the wear volume measured for the SiC reference material.

### Example 5

### Results of Brine Treatment of Si—CrSi₂ Alloys

The data in FIG. 6A show fracture toughness of the Si—CrSi₂ alloy samples prepared by rotational casting after elevated temperature exposure (1000° C. for 24 h) and after a 4-6 month treatment of the as-cast and thermally-treated Si—CrSi₂ materials in brine. As can be seen, there was no observable change in the fracture toughness of the samples after heat treatment or environmental exposure. The wear resistance of the samples also showed no observable change, and no measureable amount of Cr leached in the brine bath. The stability of the materials upon thermal/environmental exposure and the lack of leaching indicates they may be suitable for prolonged usage as valve components in a seawater environment, similar to those found in the oil and gas industry.

### Example 6

### Rotational Casting and Testing of a Si—CoSi₂ Eutectic Alloy Composition

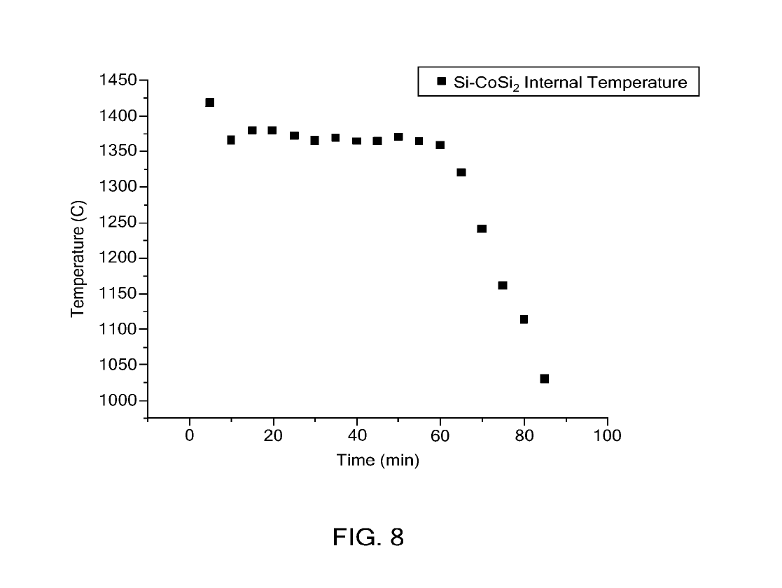

313 lb of a Si—CoSi₂ eutectic alloy composition was prepared using rotational casting in a 15-inch diameter Cercast-lined steel cylinder (mold) of 24 inches in length. See Table 4 (sample D) and the Experimental Details section below. During solidification, the internal temperature of the mold was monitored and is shown in FIG. 8. As can be seen, the temperature of the liquid was higher than the eutectic temperature (1260° C.) until the material solidified after about 65 minutes.

When prepared using vacuum casting and static vacuum induction melting, Si—CoSi₂ has a fish-bone/lamellar microstructure. This structure develops because the volume fraction is 57% CoSi₂ and there is similarity between the cubic disilicide and cubic silicon matrix. The previously characterized vacuum cast Si—CoSi₂ eutectic has a toughness of ˜2.5 MPa·m^{1/2} and a compressive strength of ˜1500-2000 MPa and provides the opportunity for a differentiated product compared to Si—CrSi₂, in terms of higher strength, but lower toughness.

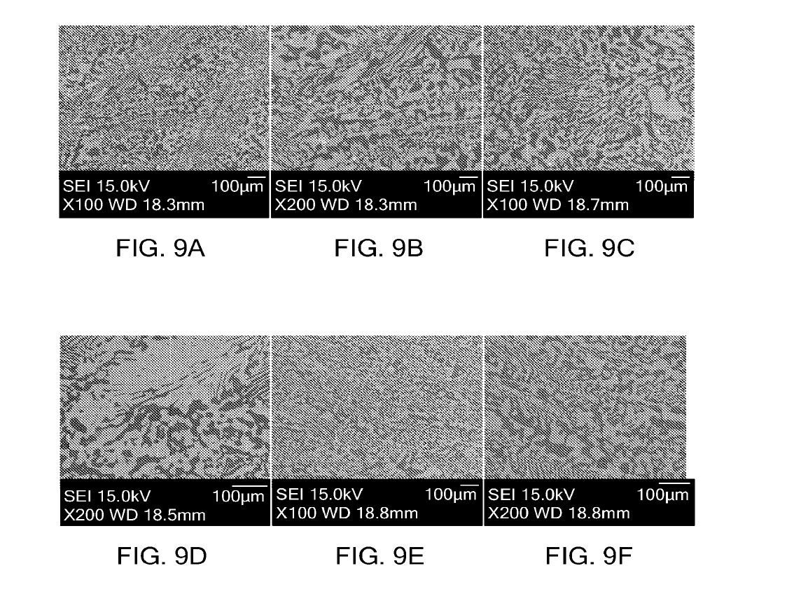

The cylindrical casting prepared by rotational casting was cracked during cooling and further reduced in size using a hammer. The pieces from three different sections (end, ¼, and center) of the casting were then cut and polished to prepare samples for flexure strength, wear testing, fracture toughness, and microstructural characterization. Scanning electron microscope (SEM) images of the microstructure of the Si—CoSi₂ are shown in FIGS. 9A-9F. Some oriented growth of the fish-bone microstructure is apparent.

The mechanical properties of the Si—CoSi₂ castings were measured according to the appropriate ASTM standards. Fracture toughness values of 3.54 (0.5) MPa·m^{1/2} and 2.6 (0.6) MPa·m^{1/2} were measured for the A and B sections of the casting. These toughness values are similar to the measured toughness in Si—CoSi₂ prepared by vacuum casting. The differences observed from the two sections of the casting reflect inhomogeneities that may be due to a difference in cooling rates within a single casting. The wear properties of this sample were investigated using the ASTM reciprocating wear test, and the wear volume (2-4 μm³) measured was similar to that of the vacuum cast material. Due to the fish-bone microstructure, the CoSi₂ eutectic alloy may have a limited ability to directionally solidify.

### Example 7

### Influence of Casting Diameter on Rotational Solidification of Si—CrSi₂ Eutectic Alloys

It is well known that the rate of cooling during eutectic solidification can impact the eutectic spacing and size. The spacing is related to the growth velocity as

$$λ = \sqrt{\frac{c}{v}}$$

where λ is the rod spacing, c is a constant related to the volume fraction and surface energy of the two phases, and v is the growth velocity. It is proposed that the diameter of the rotational casting (which is indicative of the amount of material) can modify this cooling rate, thereby affecting the microstructure and mechanical properties of the resulting solidified casting.

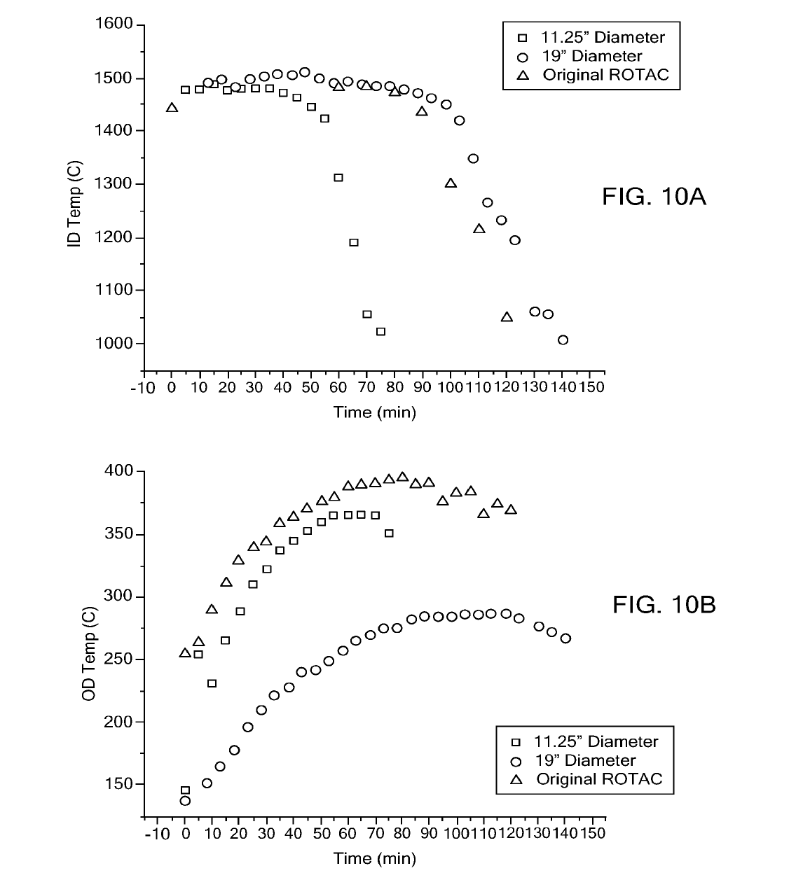

For each casting (samples A, B, and C in Table 4), the temperature of the interior and exterior of the mold was measured after pouring and is shown in FIGS. 10A-10B. Clear differences between the cooling rates are observed for the three different diameters of the Si—CrSi₂. In the case of the 19-inch diameter casting having a thickness of about 4.5 inches, the time for the interior to solidify, approximately 1 hr and 10 min, represents a growth rate of the solidification front of approximately 1.6 mm/min. The 11.25″ diameter mold, which has the same thickness of casting, solidified over approximately 55 min, which corresponds to a growth rate of the solidification front of about 2.1 mm/min. This ˜30% increase in growth rate is expected to result in a decrease in the size and spacing of the rod-like CrSi₂ phase. In fact, the size dependence of the microstructure is consistent with what is expected based on the known relationship between microstructure and growth rate, where d is inversely related to the square root of the growth speed. These changes in growth rate can result in differences in the microstructure observed and in the resulting mechanical properties.

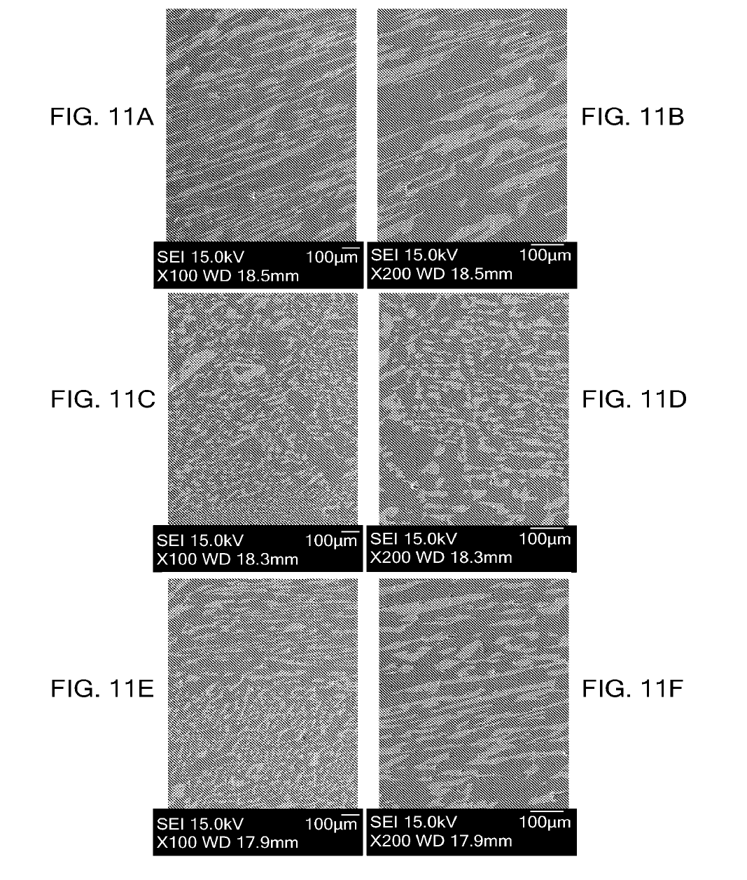

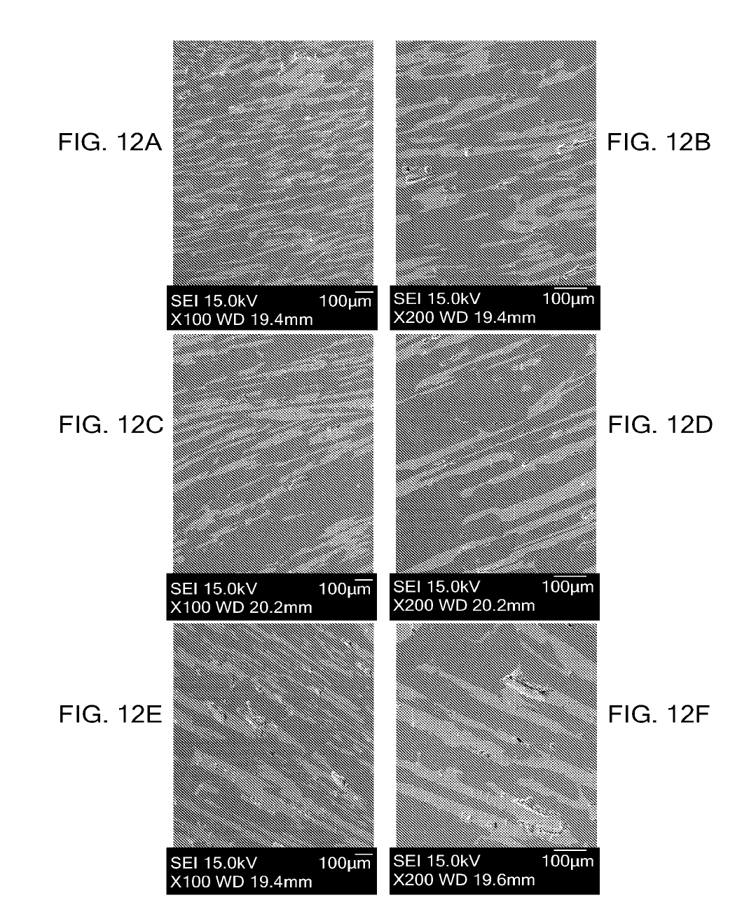

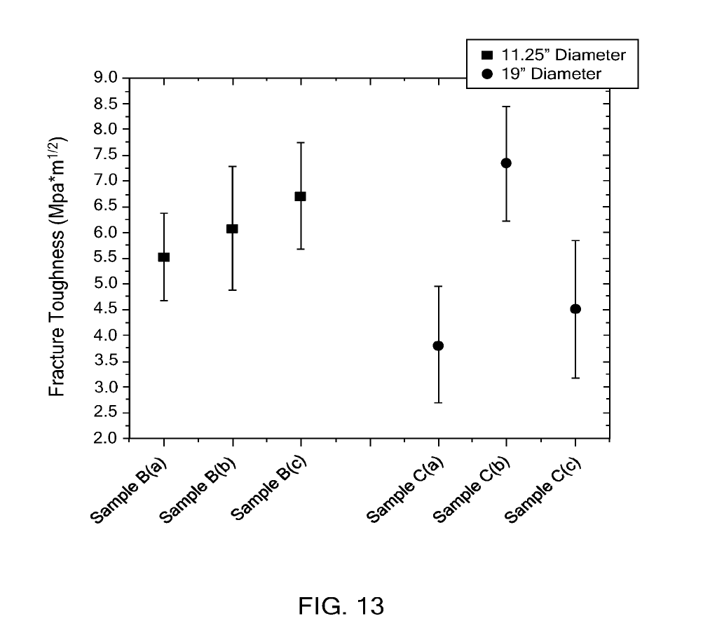

Scanning electron microscope images of the 19-in and 11.25-in diameter castings are shown in FIGS. 11A-11F and FIGS. 12A-12F. It is clear that the smaller diameter casting (FIGS. 11A-11F), which cooled 30% faster than the larger diameter casting (FIGS. 12A-12F), has a finer microstructure.

The average second phase particle size and spacing for the castings were determined by phase analysis using the radial average auto-correlation function in ImageJ. The analysis reveals that the 11.25-in casting has much smaller diameter rods with shorter lengths compared to the 19-in casting. The average rod diameter in the 11.25-in casting is about 26 μm and the average length of the rods is 118 μm. In the 19-in diameter casting, the average diameter is about 45 μm and length is greater than 500 μm. These differences in length and diameter may have a significant impact on the mechanical properties.

The fracture toughness measured for the two different diameter castings is shown in FIG. 13. The samples are indicated by a capital letter and the sections are indicated by small letters in parentheses; for example, Sample B(a) refers to the a-section of Sample B. The toughness of the 11.25-in diameter casting is higher than that of the 19-in diameter sample, with the exception of the b-section of the 19-in diameter casting. Additional material from this section was evaluated and validated the high toughness. The data suggest that a smaller microstructure results in a higher average toughness. There also appears to be a trend of increasing toughness toward the center (region-c) of the casting in the 11.25-in diameter ingot. In order to better understand the trend of toughness, samples were crushed and analyzed by powder X-ray diffraction.

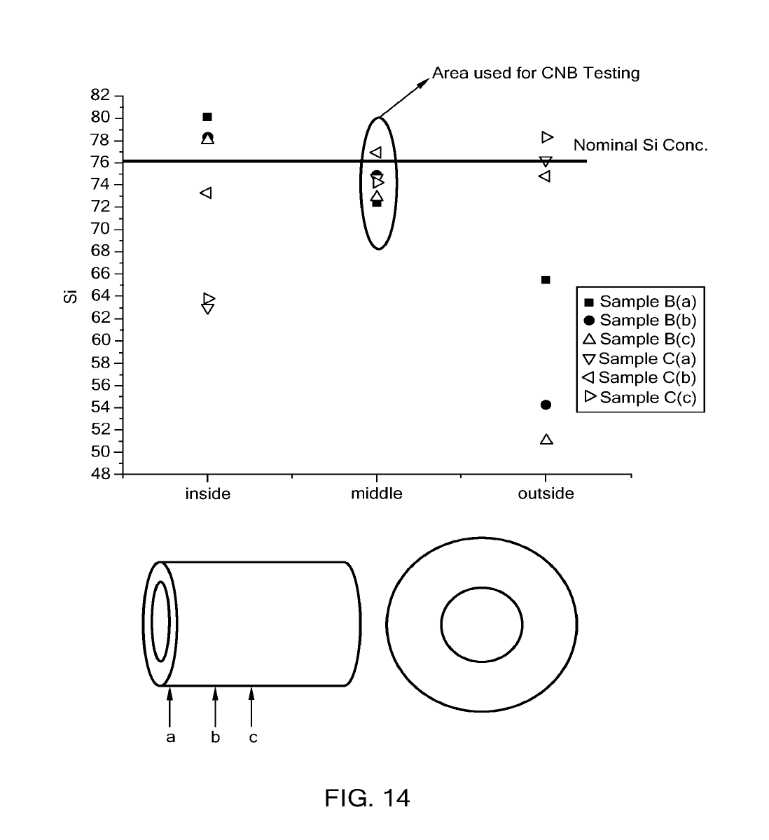

The percent Si in the eutectic alloy was determine by a least-squares regression fit of the powder X-ray diffraction data and is shown in FIG. 14. The center section, where bars were cut for chevron notch bend measurements, shows the Si fraction is consistent between the two castings and no significant deviation was observed from the nominal stoichiometry in this section of the castings. There is, however, a departure from the nominal fraction of Si at the surface and interior of the rotational cast material that may indicate that the ingots were slightly hypo- or hyper-eutectic in these regions. This phase separation may be controlled as a means of providing a gradient of composition throughout a rotationally cast ingot, thereby allowing for control over the mechanical properties across the diameter of the cylinder.

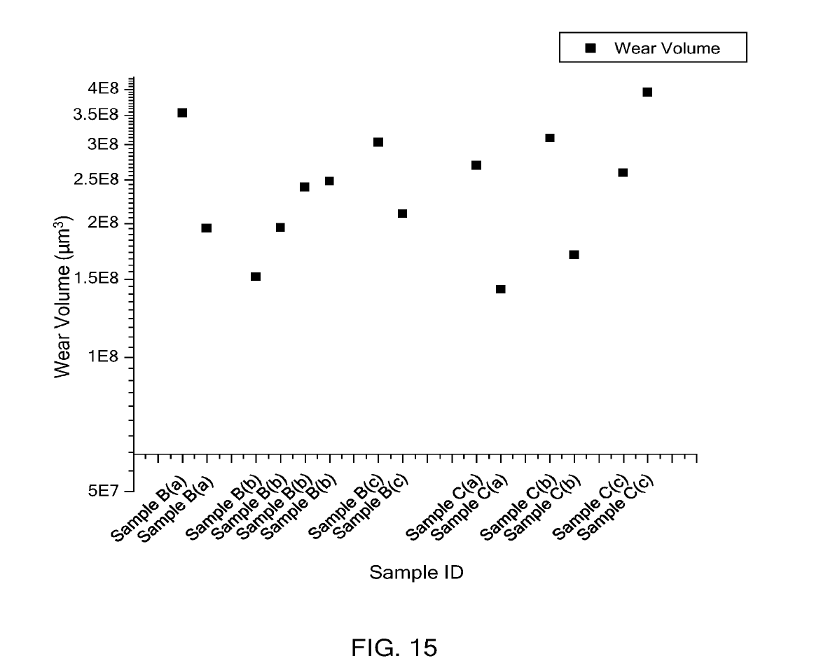

The wear behavior of the different sections of the 11.25-in and 19-in diameter castings is shown in FIG. 15. The differences in the diameters have less of an impact on the measured wear volume than on the measured fracture toughness. It is also possible that the wear properties are skewed because of differences in the wear track buildup of abrasion layers at the ends of the reciprocating tracks rather than actual differences in the wear behavior of the castings. Regardless, it appears that the volumes removed are significantly higher than the vacuum cast Si—CrSi₂ samples.

The compressive strength was also measured as a function of casting diameter. 29 specimens were machined from the 19-in diameter casting and tested; 11 were cored in a direction parallel to the direction of grain growth, while the remaining 18 were cored in a direction perpendicular to grain growth. The 11 parallel specimens were tested at rate of 0.51858 mm/min displacement, an appropriate rate to induce failure in an adequate amount of time. Of the 11 samples, 5 (45.5%) resulted in failure modes acceptable for use in determining the compressive strength of the composite in the parallel direction of grain growth. Unfavorable failure included unstable crack propagation, which is induced by splitting and peeling. Proper failure results in pulverization of the sample center.

Of the 18 testable specimens cored perpendicular to grain growth, the initial 9 were tested at a rate of 0.51858 mm/min and resulted in 3 valid tests. As a result, the second 9 were tested at 0.17286 mm/min, and 5 resulted in acceptable failure modes. In the parallel direction, an average compressive strength of 600±65 MPa was found; whereas, in the perpendicular direction, an average compressive strength of 306±81 MPa was calculated.

A total of 18 samples machined from the 11.25-in diameter casting were deemed suitable for testing; 7 of these were cored in a direction parallel to the direction of grain growth, while the remaining 11 were cored in a direction perpendicular to grain growth. The parallel specimens were tested at a rate of 0.33894 mm/min displacement. In the parallel direction, an average compressive strength of 577±95 MPa was found; whereas, in the perpendicular direction an average compressive strength of 465±60 MPa was calculated. The strengths of these rotationally cast materials may be improved by reducing defect density in the castings.

### Example 8

### Influence of Inert Mold Liners on Solidified Alloys

During casting, an interface material (e.g., SiO₂) is typically employed to inhibit reactions between the melt and the ceramic (e.g., Cercast) mold liner. In previous casting experiments, it was found that SiO₂ could migrate through the radius of the ingot and be deposited at the center of the cylindrical casting. Accordingly, several alternative materials were tested.

First, a SiC abrasive was used as a mold wash. SiC was found to be non-reactive with the Si—CrSi₂ eutectic by DSC and thus suitable for use as an inert liner. In addition to the SiC, graphite foil (e.g., “Graphoil”) was also employed, initially in a rolled configuration held in place by centrifugal force during casting (without any adhesive). In another experiment the graphite foil was held in place against the inner wall of the mold using an adhesive (in this example, phenolic resin). Generally, it was found that the use of inert mold liners significantly improves the performance of the rotationally cast Si—CrSi₂. The results of each of these trials are discussed in more detail below.

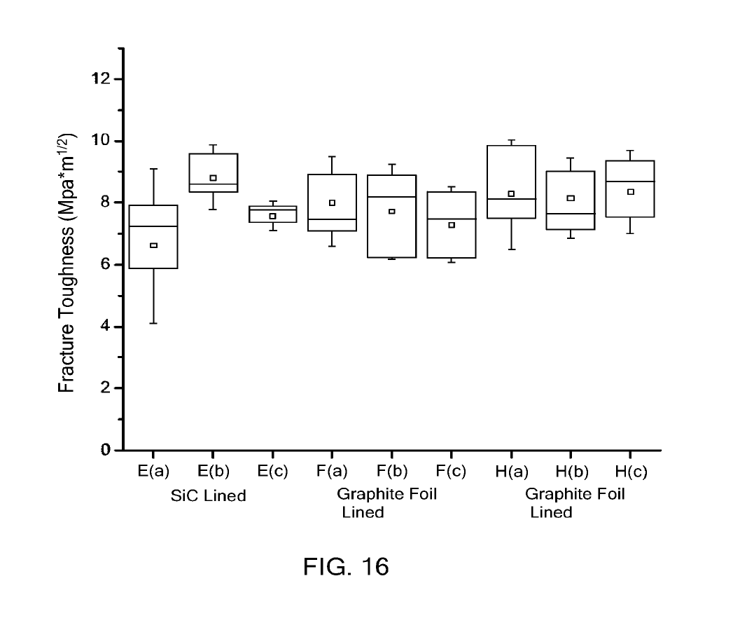

The fracture toughness of the various samples (E, F and H) prepared with different mold liners are compared in FIG. 16. In contrast to the previous castings with similar diameter (11.25-in), there does not appear to be as strong of a dependence of the toughness on the location within the casting. There is no significant difference between the different regions within each of the ingots with the SiC liner or either of the Graphoil lined castings. Additionally, the measured toughness is higher (about 7.5 MPa·m^{1/2}) compared to the previous casting (˜5-6.5 MPa·m^{1/2}). It appears that the use of inert mold liners has a positive impact on the homogeneity of fracture toughness within the casting.

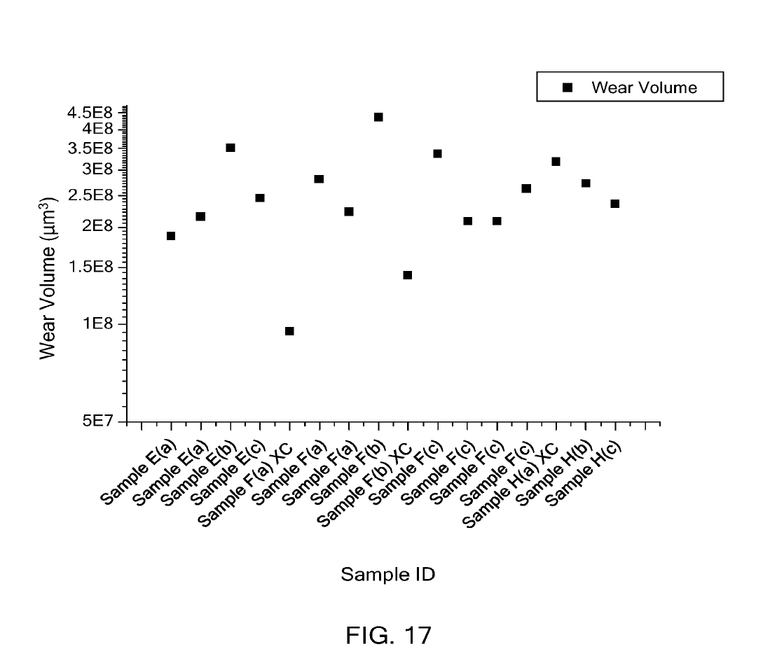

The wear properties of each of the castings prepared with different mold liners were also measured and compared to the previous casting of similar size and volume. The wear volume was measured according to ASTM G-133. As shown in FIG. 17, all of the samples have similar wear behavior, with the exception of the cross-sectioned samples. These samples have slightly lower wear behavior due to the interaction with a higher number density of the CrSi₂ reinforcing rods. The cross section is the most likely to encounter abrasion during application as a tube liner and is expected to have a lower wear rate compared to the direction parallel to growth.

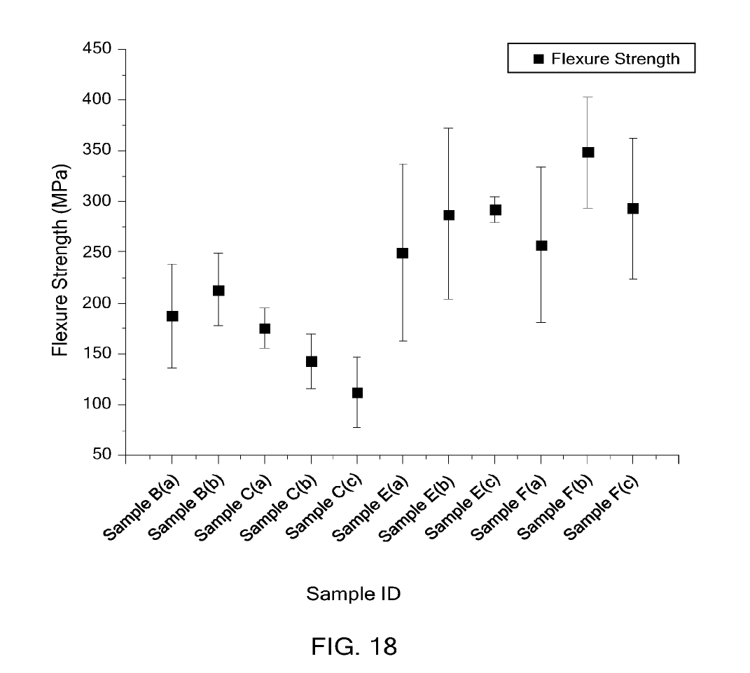

The flexure strength of several different Si—CrSi₂ castings prepared with different diameter and mold coatings is shown in FIG. 18. The samples prepared using SiO₂ as a mold liner exhibit a much lower and more variable flexure strength. A difference exists between the flexure strength of samples with larger diameter vs. smaller diameter; however, there is some variation within each casting and possibly some trends related to the section of each casting.

The samples prepared with an inert mold liner have a higher average flexure strength comparable to typical ceramics such as alumina (˜350 MPa) or boron carbide (˜250 MPa), but not as high as SiC (450-500 MPa). The flexure strength is of importance in a number of potential automotive and military applications. It appears that the presence of an inert interaction layer between the molten Si and the mold interface is advantageous to improve the mechanical reliability of eutectic silicon alloys. It is expected that other liner materials, such as graphite or SiC, to prevent any secondary material contamination in the melt or the solidified material.

To summarize, silicon eutectic alloys having an oriented microstructure can be prepared through a rotational casting processes. These oriented eutectics can be tuned further in size by variation in the diameter of the casting mold where larger castings that cool slowly tend to form larger reinforcing rods. It has also been demonstrated that the mold liner in this casting process makes a significant difference in the homogeneity and can also significantly improve the fracture toughness when inert liners were used. A table summarizing the mechanical properties of these structural materials is included below.

TABLE 5
Summary of Measured Mechanical Properties
of Rotational Cast Si-Rich Eutectic Alloys

| | | Fracture | | Wear | Flexure |
|---|---|---|---|---|---|
| | | Toughness | Compressive | Volume | Strength |
| | Composition | (MPa m^{1/2}) | Strength (MPa) | (μm³) | (MPa) |
| A | Si—CrSi₂ | 6 | ∥ 600-800 | 3 × 10⁷- | NM |
| | | | | 2 × 10⁸ | |
| B | Si—CrSi₂ | 5.5-6.7 | ⊥ 465 | 1 × 10⁸- | 175-225 |
| | | | ∥ 577 | 3 × 10⁸ | |
| C | Si—CrSi₂ | 3.8-7.3 | ⊥ 306 | 1 × 10⁸- | 100-175 |
| | | | ∥ 600 | 4 × 10⁸ | |
| D | Si—CoSi₂ | 2.6-3.5 | NM | 2 × 10⁸- | NM |
| | | | | 4 × 10⁸ | |
| E | Si—CrSi₂ | 6.6-8.8 | | 1 × 10⁸- | 250-300 |
| | | | | 3 × 10⁸ | |
| F | Si—CrSi₂ | 7.4-7.9 | | 1 × 10⁸- | 250-350 |
| | | | | 3 × 10⁸ | |
| G | Si—CrSi₂ | NA - Sample too small for testing | | | |
| H | Si—CrSi₂ | 8.2-8.3 | | 2 × 10⁸- | NM |
| | | | | 3 × 10⁸ | |

### Experimental Details

### 1. Rotational Casting Trials

Rotational casting trials were performed at Geronimo Alloys (Geronimo, Tex.). Elemental starting materials were weighed to an accuracy of 0.1 lb. Silicon (Intermediate C and PV1101, Dow Corning), chromium (Remelt Sources, 99.66%), and cobalt (Remelt Sources, 99.8%) were used as-is without additional purification. The elemental starting materials were melted in an Inductotherm 1000 lb induction furnace with an alumina ceramic crucible (Engineered Ceramics Hycor model CP-2457). Various mold liners, including SiC, graphite-foil, and silica, were added to the Cercast lined steel tubes. The tube was rotated by a centrifugal casting apparatus (Centrifugal Casting Machine Co., model M-24-22-12-WC) at a speed of ˜2000 RPM to facilitate centrifugal forces required to hold the molten material on the surface of the mold liner. The silicon and appropriate metals were heated in a alumina crucible. The melt was raised to an appropriate superheat temperature before pouring into a heated transfer ladle. An appropriate superheat temperature was determined to be ˜100-150° C. above the eutectic melt temperature. The transfer ladle was moved into position below the melt furnace and all of the molten material was transferred. The transfer ladle was then moved into position at the end of the centrifugal casting apparatus and the molten material was poured into the spinning mold through a heated refractory lined funnel. The pour speed was adjusted during the pour to ensure the material filling the refractory was not able to solidify during the pour. The casting was allowed to cool while spinning and the temperatures of the interior and exterior of the mold were recorded using a hand-held pyrometer (OS524 infrared thermometer, Omega Engineering, Inc., Stamford, Conn.). The casting was then removed from the mold and allowed to cool to room temperature, after which the cylindrical castings were divided for characterization.

### 2. Procedure for Preparing Chevron Notch Bars

The cylindrical sample was sectioned into a, b, and c regions according to the diagram shown in FIG. 14. (“a” being from the outer edge, “c” being from the very center, and “b” being taken from between “a” and “c”). Each of these sections was cut into bars that are 3.00 mm×4.00 mm×45.00 mm (±0.05 mm) and notched according to ASTM 1421. First, each section was cut it into a more manageable piece to work with (˜50 mm×60 mm×70 mm) using a Buehler Oscillamet Abrasive Cutter (4500 RPM). Once a reasonable piece was cut, the Allied Techcut 5 (4000 RPM) was used to cut the sample into plates ˜4.50-5.00 mm thick. The plates were then ground to the appropriate thickness using a Buehler Standard Polisher (4500 RPM), (using the 70 μm Dia-Grid Polishing Pad by Allied High Tech Products) to precisely to 4.00 mm (±0.05 mm) thick. If plate was ground too far, the thickness was adjusted to precisely 3.00 mm (±0.05 mm). These plates were then cut to a 45.00 mm length. The plates were then cut into rectangular parallelepipeds using the Buehler Isomet 1000 Precision Saw (900 RPM). Once the plates were cut and ground to the correct length and thickness, they were attached to a piece of precut glass on top of a steel mount using a small amount of SPI Supplies Crystalbond 509 Mounting Adhesive. A MTI Precision CNC Saw (3000 RPM) was then used to cut precise bar-shaped samples. The Crystalbond was removed with acetone and the dimensions of the bars verified. If the bars were not within spec (3.00 mm×4.00 mm×45.00 mm (±0.05 mm)), they were ground to the correct dimension. The bars were then notched using a custom sample holder using the MTI Precision CNC Saw (3000 RPM).

### 3. Procedure for Preparing Flexure Bars

A similar procedure to the CNB bar preparation was used to prepare bars 3 mm×4 mm×45 mm in size suitable for flexure testing. The bars were polished to appropriate finish using the Buehler Standard Polisher (4500 RPM) with the sequence of 30 μm, 15 μm, and 9 μm pads, polish both sides of the sample to 3.05 mm. The 6 μm pad and the 6 μm Allied Polycrystalline Diamond Suspension Water-Based Fluid were used to polish the sample on both sides until the entire samples has a smooth mirror finish. Repeat this step with the 1 μm and 0.05 μm pads and fluids. Flexure test measurements were performed using a 3-point bend configuration on at Bruker UMT-3 universal mechanical test system with a maximum load capability of 1 kN. Care was taken to follow ASTM C1161 with the following modifications. The spacing of the 10 mm diameter bearings was set to 32 mm rather than using a 40 mm spacing and 4.5 mm diameter bearings. This configuration was adjusted due to the Bruker set-up configuration and may be modified in the future. All other test procedures were followed according to the ASTM standard.

### 4. Procedure for Preparing Wear Samples

A section of each casting from section a, b, and c was broken into about 10 mm×30 mm×30 mm sections to fit in the potting cups. A mix of Buehler Epoxy Resin, Hardener, and Conductive Filler at a ratio of 15:3:15 was poured into potting cups to encase the sample. This mixture was allowed to harden for 24 hours and was then removed from the potting cups. Grinding was performed with the 70 μm Dia-Grid Polishing Pad by Allied High Tech Products. Then, a sequence of 30 μm, 15 μm, and 9 μm diamond polishing pads were used to polish the sample smooth or until no visible scratches. A 6 μm pad and the 6 μm Allied Polycrystalline Diamond Suspension Water Based Fluid followed by the 1 μm and 0.05 μm pads and fluids were used to finalize the polish of the sample.

### 5. Compressive Strength Measurements

Test specimens from cast materials were machined according to specimen dimensions, specifications, and tolerances defined in ASTM C1424-10, appendix X2. From blocks of the cast samples, oversized cores were milled using a Bridgeport vertical milling machine modified for ceramic machining and equipped with diamond tipped coring bits. The cored samples were then centerless ground to the appropriate diameter (12.64-12.76 mm) using a DedTru Model C centerless grinding adapter manufactured by Unison Corporation fitted to a Harig surface grinder equipped with a 220 grit (˜60 micron) diamond grinding wheel. The cored and ground samples were then cut into smaller cylinders using a diamond coated blade. Finally, the samples were ground to the appropriate height (6.32-6.35 mm) using a Harig surface grinder equipped with a 220 grit (˜60 micron) diamond grinding wheel.

Testing was conducted using a 5985 200 kN maximum capacity Instron universal mechanical test frame. The test fixture included an upper and lower 50 mm-diameter compression platen rated for a maximum load of 200 kN. The upper platen was mounted to the working crosshead via a self-aligning spherical seat rated for 300 kN maximum load attached directly to the 250 kN load cell. The lower platen was mounted directly to the base unit of the mechanical test frame. Testing methodology specified by ASTM C1424-10 was followed. Tungsten carbide-cobalt cermet discs (25.4 mm diameter×15 mm height) were used as loading blocks between the compression platens and the test specimen when performing analyses. The loading blocks were manufactured at Innovative Carbide with a surface roughness tolerance of 0.10 micrometers. A displacement rate controlled test mode was used to apply the compressive force. The minimum acceptable rate for SiCr eutectic samples with an elastic modulus of 178 GPa is 0.17826 mm/min which corresponds to a strain rate of 10⁻⁵ s⁻¹. The maximum allowable rate is 1.92 mm/min which corresponds to a strain rate of 15⁻¹ s⁻¹.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

1. A method of making a eutectic alloy composition by rotational casting, the method comprising:
melting together silicon and one or more metallic elements M to form a eutectic alloy melt comprising the silicon and the one or more metallic elements M;
rotating a mold containing the eutectic alloy melt about a longitudinal axis thereof, the mold being rotated at a speed sufficient to form a rotating volume of the eutectic alloy melt in contact with an inner surface of the mold;
directionally removing heat from the rotating volume of the eutectic alloy melt to directionally solidify the eutectic alloy melt, thereby forming a eutectic alloy composition including the silicon, the one or more metallic elements M, and a eutectic aggregation of a first phase comprising the silicon and a second phase of formula MSi₂, the second phase being a disilicide phase.

2. The method of claim 1, wherein directionally removing heat from the rotating volume comprises moving a solidification front therethrough, the solidification front defining an interface between the eutectic alloy melt and the eutectic alloy composition and traveling at a rate of from about 0.1 millimeters per minute to about 3 millimeters per minute through the rotating volume.

3. The method of 2, wherein an outer surface of the mold is cooled at a rate of at least about 100 degrees Celsius (° C.) per minute, a wall of the mold separating the outer surface from the inner surface.

4. The method of claim 1, wherein a non-reactive thermally conductive liner is disposed between the inner surface of the mold and the eutectic alloy melt.

5. The method of claim 1, wherein the eutectic alloy melt is directionally solidified in a vacuum environment or in a nonreactive gas environment within the mold.

6. The method of claim 1, wherein the melting together comprises heating the silicon and one or more metallic elements M to a temperature at or above a superheat temperature of the eutectic alloy composition.

7. The method of claim 1, wherein the disilicide phase is selected from the group consisting of CrSi₂, VSi₂, NbSi₂, TaSi₂, MoSi₂, WSi₂, CoSi₂, TiSi₂, ZrSi₂, and HfSi₂, and the one or more metallic elements M is selected from the group consisting of Cr, V, Nb, Ta, Mo, W, Co, Ti, Zr and Hf.

8. A silicon eutectic alloy composition comprising:
a body comprising a eutectic alloy including silicon, one or more metallic elements M, and a eutectic aggregation of a first phase comprising the silicon and a second phase of formula MSi₂, the second phase being a disilicide phase,
wherein one of the first and second phases of the eutectic aggregation comprises one or more colonies of substantially aligned high aspect ratio structures;
wherein the body comprises a fracture toughness of at least about 3.2 megaPascals·meter^{1/2}(MPa·m^{1/2}).

9. The silicon eutectic alloy of claim 8, wherein the fracture toughness is at least about 7.5 MPa·m^{1/2}.

10. The silicon eutectic alloy of claim 8, wherein the disilicide phase is selected from the group consisting of CrSi₂, VSi₂, NbSi₂, TaSi₂, MoSi₂, WSi₂, CoSi₂, TiSi₂, ZrSi₂, and HfSi₂, and the one or more metallic elements M is selected from the group consisting of Cr, V, Nb, Ta, Mo, W, Co, Ti, Zr and Hf.

11. A silicon eutectic alloy composition comprising:
a body having symmetry about a longitudinal axis thereof, the body comprising a eutectic alloy including silicon, one or more metallic elements M, and a eutectic aggregation of a first phase comprising the silicon and a second phase of formula MSi_{2,} the second phase being a disilicide phase,
wherein one of the first and second phases of the eutectic aggregation comprises high aspect ratio structures oriented along a radial direction with respect to the longitudinal axis.

12. The silicon eutectic alloy composition of claim 11, wherein the high aspect ratio structures comprise an average lateral dimension of from about 0.5 micron to about 50 microns and an average length of from about 10 microns to about 1000 microns.

13. The silicon eutectic alloy composition of claim 11, wherein the first phase is an elemental silicon phase and wherein the disilicide phase is selected from the group consisting of CrSi₂, VSi₂, NbSi₂, TaSi₂, MoSi₂, WSi₂, CoSi₂, TiSi₂, ZrSi₂, and HfSi₂, and the one or more metallic elements M is selected from the group consisting of Cr, V, Nb, Ta, Mo, W, Co, Ti, Zr and Hf.

14. The silicon eutectic alloy composition of claim 11, wherein the first phase is an intermetallic compound phase selected from MSi and M₅Si₃ and the disilicide phase is selected from the group consisting of CrSi₂, VSi₂, NbSi₂, TaSi₂, MoSi₂, WSi₂, CoSi₂, NiSi₂, and TiSi₂.

15. The silicon eutectic alloy composition of claim 11, wherein the eutectic alloy comprises at least about 50 at. % Si.
